(19) United States
(12) Patent Application Publication
(10) Pub. No.: US 2024/0250841 A1
(43) Pub. Date: Jul. 25, 2024

(54) Hierarchical Framework of Contexts for the Smart Home

(71) Applicant: Google LLC, Mountain View, CA (US)

(72) Inventors: Daniele Midi, San Francisco, CA (US); Chrisoula Kapelonis, San Jose, CA (US); Husain Bengali, Redmond, WA (US); Andrew Larsen Axley, Bend, OR (US); Marci Meingast, San Francisco, CA (US); Lindsay Jane Graves, San Carlos, CA (US); Jacob Antony Arnold, Boulder, CO (US)

(73) Assignee: Google LLC, Mountain View, CA (US)

(21) Appl. No.: 18/602,343

(22) Filed: Mar. 12, 2024

Related U.S. Application Data
(60) Provisional application No. 63/556,036, filed on Feb. 21, 2024.

(51) Int. Cl. H04L 12/28

(52) U.S. Cl. CPC H04L 12/2807; H04L 12/282

(57) ABSTRACT

Techniques and devices for a hierarchical framework of contexts for the smart home are described for managing modes in a smart home system by an electronic device. The electronic device receives a first input of a model for a second operational mode of a smart home system and receives a second input of the model for the second operational mode of the smart home system. Based on the first input and the second input, the electronic device determines an effective time interval for the second operational mode that is effective to cause the smart home system to transition from a first operational mode to the second operational mode during the effective time interval.

### RELATED APPLICATIONS

This application claims the benefit of U.S. Provisional Application No. 63/556,036, filed Feb. 21, 2024, the disclosure of which is incorporated herein by reference in its entirety.

### SUMMARY

This summary is provided to introduce concepts of a hierarchical framework of contexts for the smart home, generally related to defining people and the areas they occupy in their home. The concepts include presence states, modes, and activities together with the rules for people and areas and their attributes that work in concert to orchestrate state transitions in a smart-home system. The concepts are further described below in the Detailed Description. This summary is not intended to identify essential features of the claimed subject matter, nor is it intended for use in determining the scope of the claimed subject matter.

In aspects, methods, devices, systems, and means for hierarchical framework of contexts for the smart home are described for managing modes in a smart home system by an electronic device. The electronic device receives a first input of a model for a second operational mode of a smart home system and receives a second input of the model for the second operational mode of the smart home system. Based on the first input and the second input, the electronic device determines an effective time interval for the second operational mode that is effective to cause the smart home system to transition from a first operational mode to the second operational mode during the effective time interval.

### BRIEF DESCRIPTION OF THE DRAWINGS

Aspects of hierarchical framework of contexts for the smart home are described with reference to the following drawings. The same numbers are used throughout the drawings to reference like features and components:

FIG. 1 illustrates an example network environment in which various aspects of hierarchical framework of contexts for the smart home can be implemented.

FIG. 2 illustrates an example environment in which various aspects of hierarchical framework of contexts for the smart home can be implemented.

FIG. 3 illustrates an example of a hierarchy of entities with which aspects of hierarchical framework of contexts for the smart home can be implemented.

FIG. 4 illustrates an example system with which aspects of hierarchical framework of contexts for the smart home can be implemented.

FIGS. 5a and 5b illustrate example timelines of an effective interval with which aspects of hierarchical framework of contexts for the smart home can be implemented.

FIGS. 6a and 6b illustrate example timelines of an effective interval with which aspects of hierarchical framework of contexts for the smart home can be implemented.

FIG. 7 illustrates an example method for an electronic device in accordance with one or more aspects of the techniques described herein.

FIG. 8 illustrates an example environment in which aspects of the techniques described herein can be implemented.

FIG. 9 illustrates an example wireless network device that can be implemented in a home area network in accordance with one or more aspects of the techniques described herein.

FIG. 10 illustrates an example system with an example device that can implement aspects of hierarchical framework of contexts for the smart home.

### DETAILED DESCRIPTION

This document describes techniques and systems for hierarchical framework of contexts for the smart home. Understanding human context in relation to the home is a core component to enabling intelligence in the smart home, but the varied and personal nature of the home makes this a complex problem. A framework for the context of the home exposes meaningful contexts to inform the user of what is happening in the home and can be used as triggers or conditions for automations, exposes controls for users to manually provide input on current and future home states, combines pattern-based predictions with sensor inputs to infer/estimate contexts, and has rules which arbitrate changes to contexts and modes to ensure they stay consistent (e.g., a person in home equates to the home is occupied). The framework defines people and the areas they occupy in their home, as well as presence states, modes, and activities together with the operational rules related to people, areas, and their attributes to work in concert. The framework further defines time windows to fuse sensed or learned state intervals with explicit user input, and the operational rules to orchestrate the corresponding state transitions. This framework allows non-expert users to concisely define home automations that work intuitively and reliably, as triggers and conditions for automations, using combinations of people presence and activities, and area presence state and modes.

### Example Environment

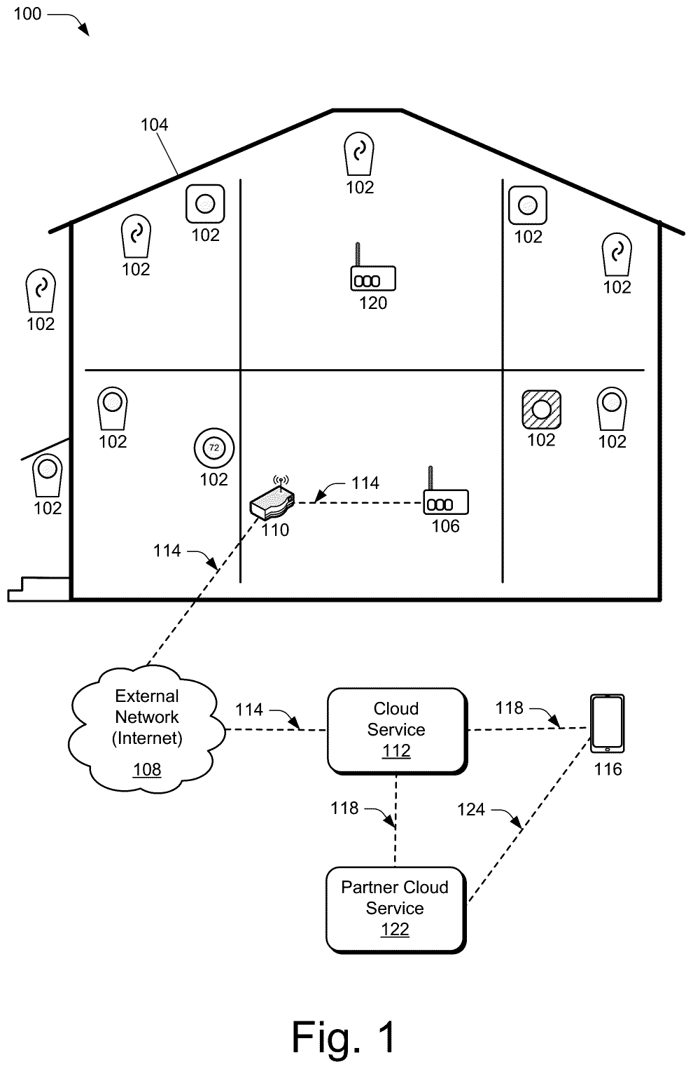

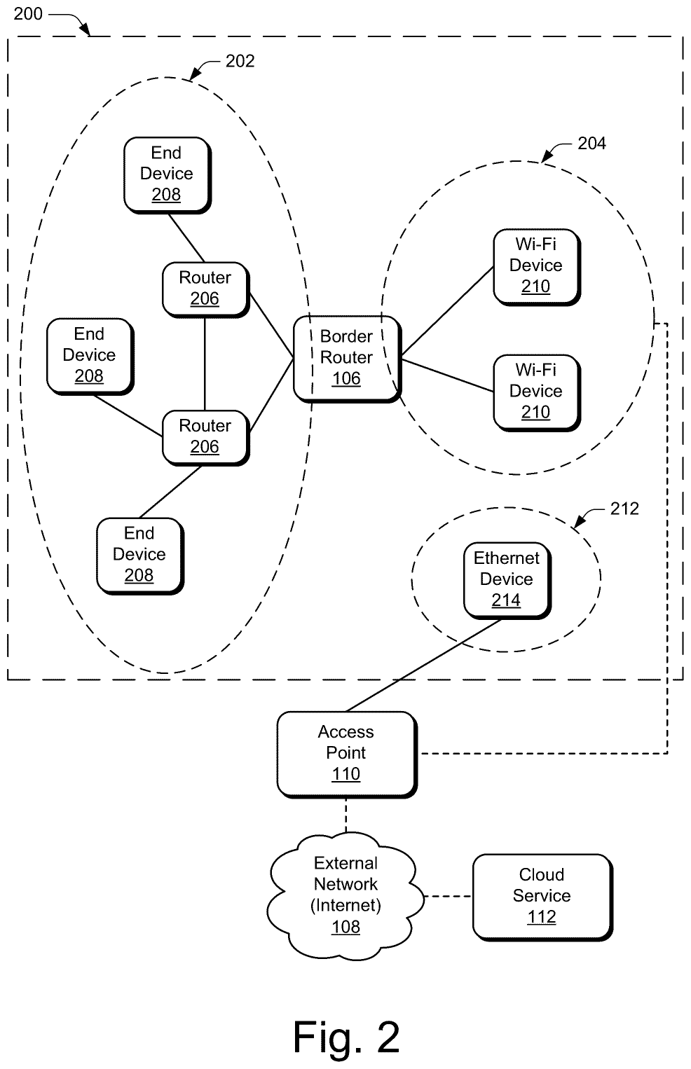

FIG. 1 illustrates an example network environment 100 in which aspects of hierarchical framework of contexts for the smart home can be implemented. The network environment 100 (e.g., a fabric network, a Thread network, a Matter network, a Weave network) includes one or more network segments that form a home area network (HAN) such as a HAN 200, described below with respect to FIG. 2. The HAN includes wireless network devices 102 that are disposed about a structure 104, such as a house, and are connected by one or more wireless and/or wired network technologies, as described below. The HAN includes a border router 106 that connects the HAN to an external network 108 (access network 108), such as the Internet, through a home router or access point 110.

To provide user access to functions implemented using the wireless network devices 102 in the HAN, a cloud service 112 connects to the HAN via border router 106, via a secure tunnel 114 through the external network 108 (access network 108) and the access point 110. The cloud service 112 facilitates communication between the HAN and internet clients 116, such as apps on mobile devices, using a web-based application programming interface (API) 118. The cloud service 112 also manages a home graph that describes connections and relationships between the wireless network devices 102, elements of the structure 104, and users. The cloud service 112 hosts controllers which orchestrate and arbitrate home automation experiences, as described in greater detail below.

The HAN may include one or more wireless network devices 102 that function as a hub 120. The hub 120 may be a general-purpose home automation hub, or an application-specific hub, such as a security hub, an energy management hub, an HVAC hub, and so forth. The functionality of a hub 120 may also be integrated into any wireless network device 102, such as a smart thermostat device, a smart television, or the border router 106. In addition to hosting controllers on the cloud service 112, controllers can be hosted on any hub 120 in the structure 104, such as the border router 106. A controller hosted on the cloud service 112 can be moved dynamically to the hub 120 in the structure 104, such as moving an HVAC zone controller to a newly installed smart thermostat. Hosting functionality on the hub 120 in the structure 104 can improve reliability when the user's internet connection is unreliable, can reduce latency of operations that would normally have to connect to the cloud service 112, and can satisfy system and regulatory constraints around local access between wireless network devices 102.

The wireless network devices 102 in the HAN may be from a single manufacturer that provides the cloud service 112 as well, or the HAN may include wireless network devices 102 from partners. These partners may also provide partner cloud services 122 that provide services related to their wireless network devices 102 through a partner Web API 124. The partner cloud service 122 may optionally or additionally provide services to internet clients 116 via the web-based API 118, the cloud service 112, and the secure tunnel 114.

The network environment 100 can be implemented on a variety of hosts, such as battery-powered microcontroller-based devices, line-powered devices, and servers that host cloud services. Protocols operating in the wireless network devices 102 and the cloud service 112 provide a number of services that support operations of home automation experiences in the distributed computing environment 100. These services include, but are not limited to, real-time distributed data management and subscriptions, command-and-response control, real-time event notification, historical data logging and preservation, cryptographically controlled security groups, time synchronization, network and service pairing, and software updates.

FIG. 2 illustrates an example environment (e.g., a fabric network, a Weave network, a Matter network) in which various aspects of hierarchical framework of contexts for the smart home can be implemented. The home area network (HAN, Thread network) 200 may include a wireless mesh network segment 202 (e.g., a Thread network segment), a Wi-Fi network segment 204, and/or an Ethernet segment 212. The mesh network segment 202 is a Wireless Personal Area Network (WPAN) implementing the Thread Specification, in particular the Thread Specification 1.0, 1.1, 1.2, 1.3, or any later version. For example, the mesh network segment 202 may be compatible with version 1.1 and/or version 1.2 of the Thread Specification. The Wi-Fi segment 204 is a Wireless Local Area Network (WLAN) implementing the IEEE 802.11 standard, in particular the IEEE 802.11 standard of 1997 and/or any later version such as 802.11b, 802.11g, 802.11n, 802.11ac, 802.11ax, 802.11ad, 802.11ay, and 802.11be. For example, the Wi-Fi segment 204 may be compatible with one or more, e.g., all, of these versions. The wireless mesh network segment 202 includes routers 206 and end devices 208. The routers 206 and the end devices 208, each include a mesh network interface for communication over the mesh network segment 202. The routers 206 receive and transmit packet data over the mesh network interface. The routers 206 also route traffic across the mesh network segment 202. The end devices 208 are devices that can communicate using the mesh network segment 202, but lack the capability, beyond simply forwarding to its parent router 206, to route traffic in the mesh network segment 202. One or more of the end devices 208 may be battery powered. For example, a battery-powered sensor is one type of end device 208. The Wi-Fi network segment 204 includes Wi-Fi devices 210. Each Wi-Fi device 210 includes a Wi-Fi network interface for communication over the Wi-Fi network segment 204. Optionally or additionally, the HAN 200 can include an Ethernet network segment 212 that includes one or more Ethernet devices 214 that connect to the border router 106 or the access point 110. The Ethernet network segment 212 may be compatible with the IEEE 802.3 standard of any version, e.g., 802.3cu or any prior version.

The border router 106 is included in the wireless mesh network segment 202 and is included in the Wi-Fi network segment 204. The border router 106 includes a mesh network interface for communication over the mesh network segment 202 and a Wi-Fi network interface for communication over the Wi-Fi network segment 204. The border router 106 routes packets between devices in the wireless mesh network segment 202 and the Wi-Fi network segment 204. The border router 106 also routes packets between devices in the HAN 200 and external network nodes (e.g., the cloud service 112) via the access network 108, such as the Internet, through a home router or access point 110.

The devices in the mesh network segment 202, the Wi-Fi network segment 204, and the Ethernet network segment 212 use standard IP routing configurations to communicate with each other through transport protocols such as the User Datagram Protocol (UDP) or the Transmission Control Protocol (TCP). When the devices in the mesh network segment 202, the Wi-Fi network segment 204 and/or the Ethernet network segment 212 are provisioned as part of a Weave network, a fabric network, or a Matter network, the devices can communicate messages over those same UDP and/or TCP transports.

### Hierarchical Framework of Contexts for the Smart Home

The framework of contexts includes two classes of entities: Areas and People. Areas are spatial locations that can include other spatial locations as well as people. For example, a house is a spatial location that includes rooms, another spatial location, and both the house and the rooms can include people. Instances of Areas are Structure, Rooms, and Outdoor areas. Areas have a Presence State with two possible values, either Occupied or Vacant, and optionally a Mode from a set of possible values dependent on a current Presence State. In some implementations the Occupied state is indicated as a Home state and the Vacant state is indicated as an Away state.

An Occupied Presence State indicates that the associated area is occupied. A set of valid Modes for the Occupied Presence State includes Sleep and Winding Down. While occupied, the Area has Occupants that includes all the People currently in that Area or in any descendent Area(s) in the hierarchy. At the structure level, the Occupied state is Home. The Occupants of an Area are aggregated into an Attendance State of the Area with one of three values: all household members are present, some household members are present, or no household members are present. While occupied, the Area may have an Activity State Set. For example, the set elements can include Sleeping, Working, Cooking, and the like. The set can include zero or more activities (interpreted in natural language as “Someone in <area> is <activity>”). The set includes the union of the Activity states of the Areas and People included in the current Area but can also include activities manually set by the users that are not associated with any individual Person in the Area (to accommodate for untracked people). Activity States and Modes are separate and do not interact with each other. For example, an Area can be in Sleep Mode without the activity state of the occupants being “Sleeping,” and conversely, the fact that some occupants have “Sleeping” as activity does not mean that any containing Area has to be in Sleep Mode.

A Vacant Presence State indicates that an area is vacant. The set of valid Modes for the Vacant Presence State includes Extended Away and Arriving. The Vacant state, at the structure level, is Away. When expressing Automation triggers in natural language, a combination of a Presence State and an Attendance State enables all needed contexts. For example:
“Everyone is away”=the structure is vacant,
“Someone is home”=the structure is occupied,
“A home member is home”=the attendance state is either some or all of the household members are home, or
“All household members are home”=the attendance state is all of the household members are home.

Automations can also directly use the modes as triggers, such as when the structure or an area is in Sleep mode, or when the structure or an area is in Extended Away mode. Since a Mode can be active if and only if the Presence State it corresponds to is active, activation of a mode would also trigger any automations with its associated presence state. For example, if the Extended Away mode is activated, the automations associated with both Vacant (Away) and Extended Away will trigger.

In terms of order of presence state and mode activation, the presence state must always activate a short duration (e.g., 5 seconds) before the mode is active. Since modes are more specific than presence states, automation actions associated with modes may be more specialized, and, hence, this delay will reduce the likelihood that automation actions associated with mode activation will be overridden by automation actions associated with the presence state. In some aspects, this delay need only be reflected in the automation execution and not in the user interface of a user's application.

Outdoor Areas are modeled as Areas with a simple flag specified by the user to specify that they are “Outdoor” and do not abide by the same entity rules as indoor areas. Outdoor areas can have a presence and activity state, but do not aggregate up to or override down from the presence or activity state of the structure.

People are household members. Non-household members can be modeled through the Presence State plus the Attendance State of Areas, and the identified presence cannot be tracked.

People have a Presence State with two possible values: Home when the person is at home and Away when the person is away from home. When a person is in the Home presence state, a Person has a Current Containing Area indicating which Area contains them and which can be a specific Room, if known, or default to the Structure area. Also, when a person is in the Home presence state, a Person has zero or one Current Activity (e.g., that Person is Sleeping, Working, or the like).

A presence state of a person is always in relation to a single home. If a person has multiple homes set up in a user application, then they will have multiple independent presence states. For example, a user can possibly be set to Home for two different homes simultaneously.

States not directly related to the home are not relevant to the hierarchical framework of contexts. The framework focuses on context that is only related to the home and its users and people. So the framework does not try to indicate anything, for example, about activity detected by a wearable fitness monitor for a user “jogging” in the park, or create modes and/or starters for automations triggered when the user is “at work” vs “at a restaurant.”

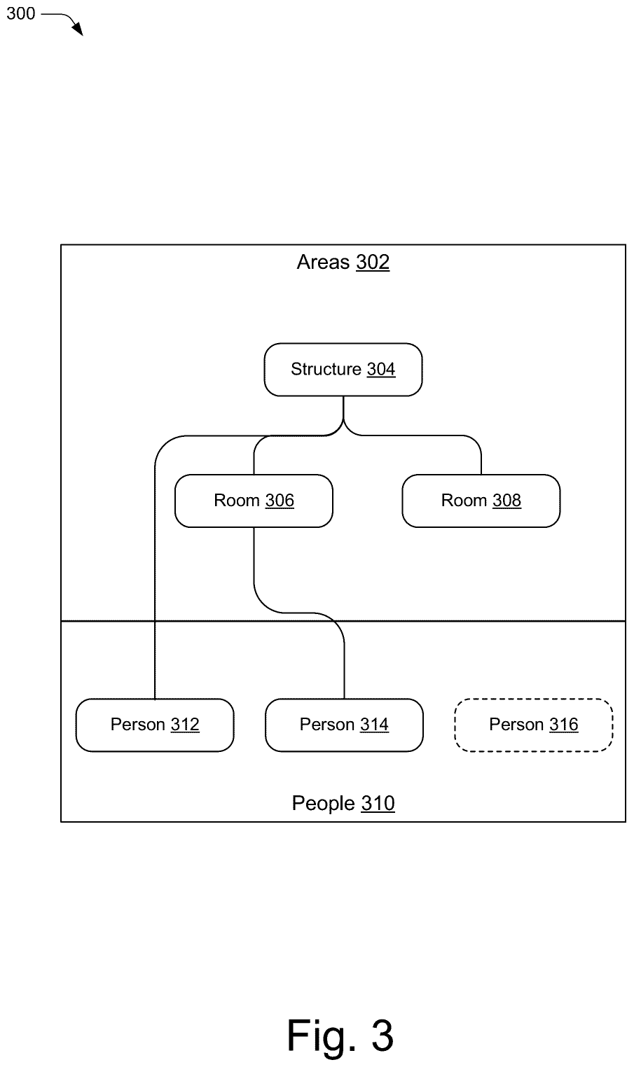

FIG. 3 illustrates an example of a hierarchy of entities 300 with which aspects of hierarchical framework of contexts for the smart home can be implemented. The hierarchy 300 includes Areas 302 and People 310. Areas 302 includes a Structure 304 that includes Room 306 and Room 308. People 310 includes Person 312, Person 314, and Person 316. Person 312 has a presence in the Structure 304. Person 314 has a presence in the Room 306. Person 312 does not currently have a presence in the Structure 304, or the rooms included in the Structure 304.

The state of the entities in the hierarchy of entities 300 can change according to rules for the hierarchy 300. In a first aspect, the Vacant presence state overrides down the hierarchy 300. For example, when the Structure 304 switches to the Vacant presence state, all child Rooms (e.g., Room 306 and Room 308) switch to the Vacant presence state and all People 310 switch to the Away presence state.

In another aspect, the Occupied and Home presence states propagate up the hierarchy 300. For example, when an Area switches to the Occupied presence state, or a Person switches to the Home presence state, all ancestors (containing Areas higher in the hierarchy) switch to the Occupied presence state. In a further aspect, Vacant rooms cannot have occupants. For example, when a Room becomes Vacant (manually or through sensing), any Occupant included in that Room must either have already have moved to a different Room, or be automatically assigned to be included by the Structure 304. If there is a conflict between manual and sensed occupancy, the model can reconcile conflicts between the sensed input and the manual (user) input for an occupant to provide a consistent presence for the occupant in the hierarchy 300.

In another aspect, Area Modes override down the hierarchy 300 with matching a Presence State. For example, when an Area changes Mode, all child Areas whose Presence State agrees with the parent's switch to that same Mode (e.g., changing the Structure 304 from the Home presence state to the Sleep mode will change the Mode of all Rooms currently occupied to the Sleep mode).

In a further aspect, Activity States accumulate up the hierarchy 300. For example, when a Person changes a Current Activity, or an Area changes an Activity State Set, the Activity State propagates up the hierarchy 300 recursively to the included entities by being unioned into the existing sets. This only affects the Activity State Sets and does not affect the Modes. In a further example, if Person 314 is currently in Room 306, Room 306 has an Activity Set={ } (an empty set) and the Structure 304 has Activity Set={Cooking}. Changing the Activity of Person 314 from Active to Sleeping will change the Activity Set of Room 306 to {Sleeping} and the Activity Set of the Structure 304 to {Cooking, Sleeping}.

The framework 300 includes the concepts of time windows and time intervals. Time intervals can be applied to Modes, Areas, People, or Activity States. A window is a time span in which a particular Area is expected to switch in and out of a particular Mode. Each window has a Target Mode (e.g., Home, Sleep, Away, Extended Away), a start time, an end time, and optionally an ingress transition Mode (e.g., Winding Down for the Sleep window, Leaving for Extended Away, or the like). Windows can be learned or suggested by a model from historical data (e.g., typical sleep and wake times, if enough data is available), or explicitly provided by the user as input to inform the system of the user's expected Mode changes (e.g., vacation start time and end time). The exact (actual) times in which the Mode is activated and deactivated are determined by the model in the moment based on existing learned or explicit windows, current sensor data, and possible user manual action. This actual time interval when the Mode is activated or deactivated determines the effective interval.

In a first example of an Extended Away with an Explicit window, the user provides an Explicit window for Extended Away in which they anticipate being gone between Friday 12 p.m. and Monday 10 a.m. When Friday 12 p.m. comes, the Structure 304 does not switch immediately but instead waits for Presence Sensing to determine that everyone is gone. Once that happens, at 1 p.m., the mode changes to Extended Away, and that is the start of the effective interval.

In another example of Sleep with a Learned window, through the use of historical data, the model determines that the Structure 304 usually switches to Sleep Mode between 10 p.m. and 7 a.m. on weekdays. Based on this historical data, the model proposes a window of 10 p.m. and 7 a.m. on weekdays for the Sleep mode to the user which the user can decide to adopt or reject.

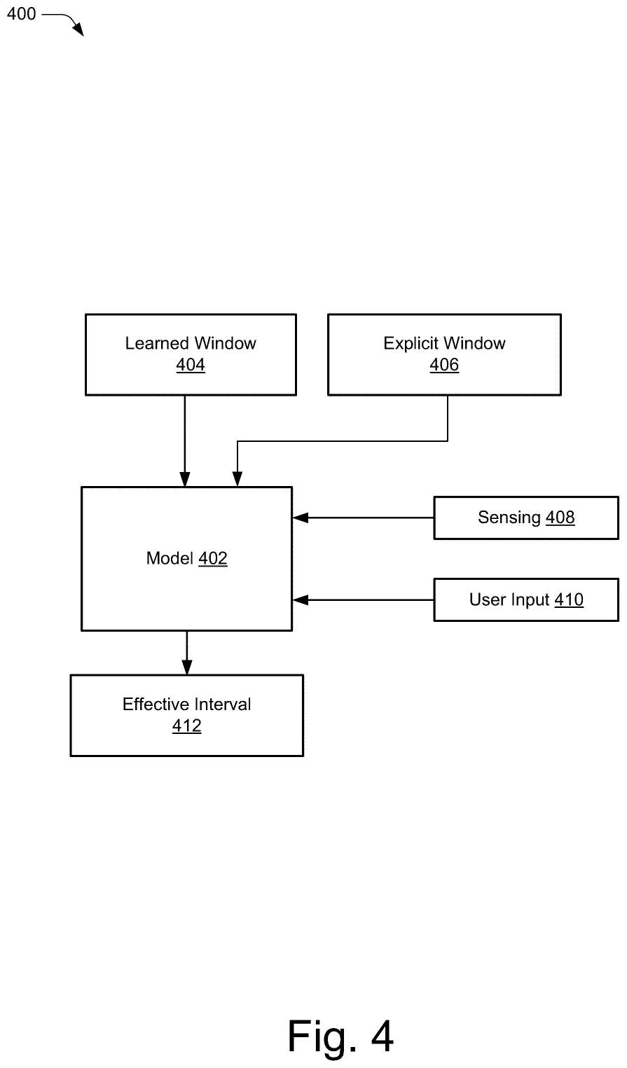

FIG. 4 illustrates an example system 400 for determining an effective interval. A model 402 receives a learned window 404 derived from historical data. The model 402 can also receive an explicit window 406 that is input by a user. The model 402, based on sensing 408, user input 410, or both, generates an effective interval 412 to enter a mode. For example, the sensing 408 can include the detection of presence by occupancy sensors, the user entering a geofenced area about a structure, or the like. An electronic device such as cloud service 112, a border router 106, or a hub 120 can implement part or all of the hierarchy 300 and the system 400, including the model 402.

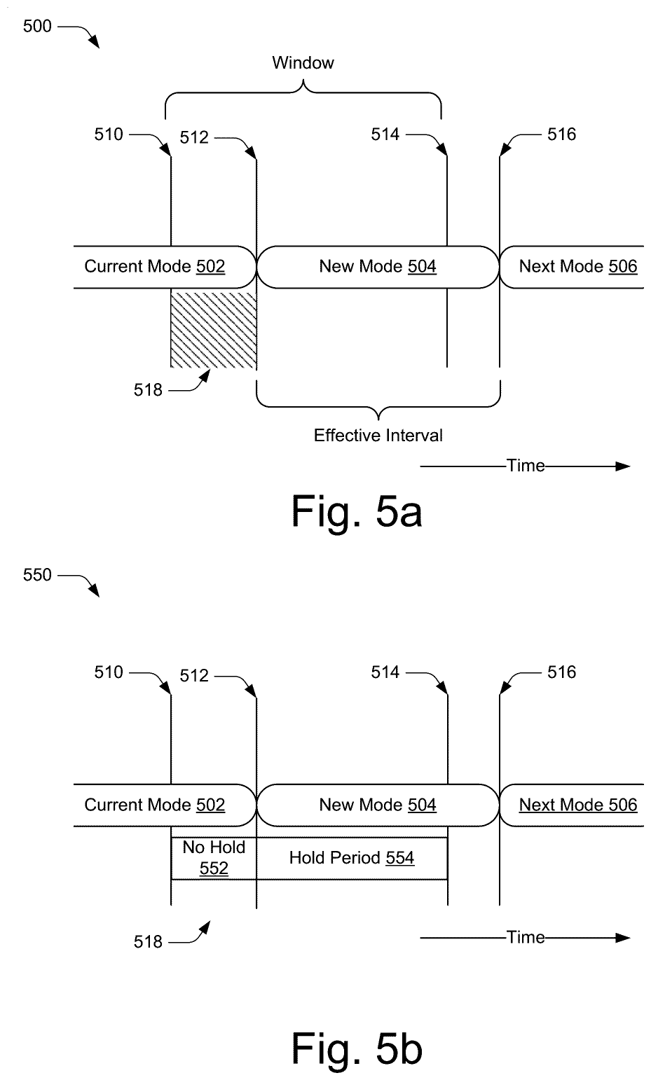

FIG. 5a illustrates an example illustration of a timeline of an effective interval at 500. Modes transition in a smart-home system over time starting with a current mode 502. At 510, the model 402 determines that a new mode 504 should begin at 510. However, the new mode 504 may start immediately at 510 or, as illustrated, the effective interval for the new mode 504 can begin at 512 after an optional ingress or delay period, indicated at 518 between 510 and 512. The window for the new mode can end at 514 if there is no delay or, as illustrated, can end at the end of the effective interval at 516. The next mode 506 begins after the end of the effective interval at 516 and can be a different mode or the same mode as the current mode 502.

In this aspect, the model 402 determines when to switch modes during a window. When a window starts, the Target Mode does not necessarily become active immediately. That is left to the model 402, determined in the moment based on existing learned or explicit windows, current sensor data, and/or possible user manual action. If there are no sensors enrolled, the model 402 will switch the mode immediately, so effectively the window acts as a schedule (the window and effective interval are the same).

In another aspect, windows hold an active target mode. When a window is active and the Target Mode is or becomes active, a hold becomes active preventing the switch away from the Target Mode until the expected end of the window (this effectively means ignoring all activity signals and individual identified presence signals). As illustrated in FIG. 5b, there is no hold of modes until the beginning of the effective interval at 512. A hold period for mode changes begins at the beginning of the effective interval at 512 until the end of the window at 514.

In a further aspect, a manual change cancels a window. A manual change of Mode will immediately switch Mode and cancel any active window that will in turn cancel any active hold.

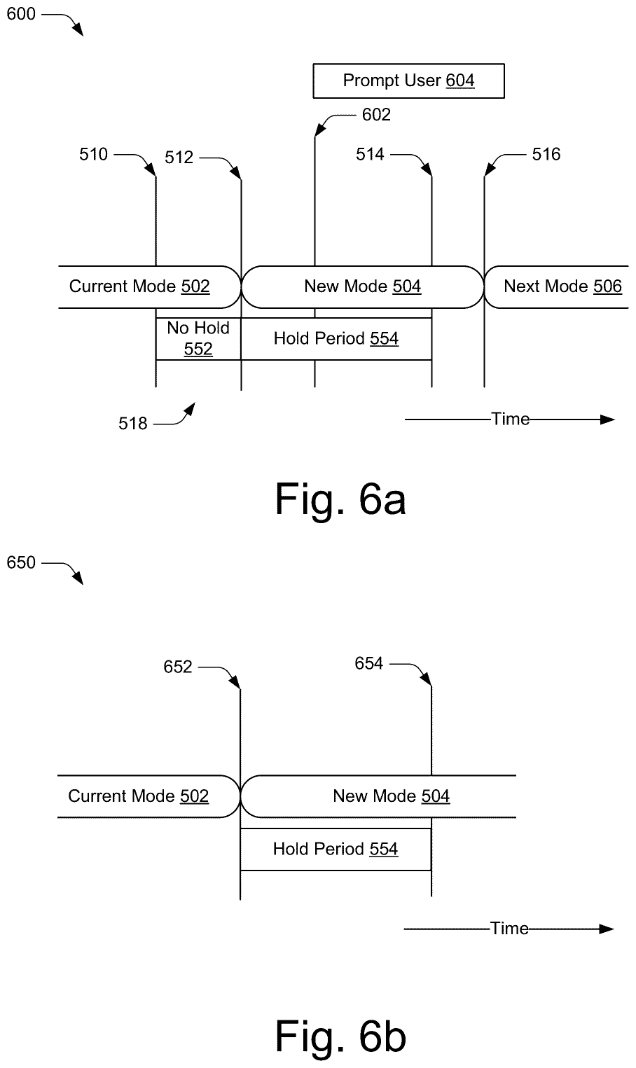

In another aspect, Attendance State changes respects a window hold but prompts the user. If changes in Attendance State (an aggregate identified presence) would switch Presence State during a hold (e.g., the current state is Occupied and all household members leave, or the current state is Vacant and some household member arrives) the hold will be honored and no Mode switch will happen automatically, but the users will be asked whether they want to switch the Presence State. As illustrated in FIG. 6a, when a user arrives (at 602) at the Structure, the user is prompted (at 604) to determine if the user wants to maintain the hold on Mode states or make a change to the Mode. For example, a Structure has Presence State=Occupied and Mode=Extended Away, and an Extended Away window hold is active. When a household member comes home, the hold will continue (no automatic Mode switch), but the user will receive a prompt asking whether they would like to change the Presence State from Vacant to Occupied (whose default Mode is “Home”). If the user is just transient, they can ignore the prompt. If instead they have come back home and would like to change the Mode, they can accept the prompt that will change the Presence State to Occupied, setting the Mode to the default of “Home,” and the window will be canceled.

In an additional aspect, Windows also represent exit allowances and manual switch holds. As illustrated in FIG. 6b, a manual Mode change, at 652, will implicitly create a window starting at the current time and of duration equal to the needed exit allowance or manual switch hold (the time span from 652 to 654). The effective interval has the same start time as the window (the time of the manual Mode change) and can extend past the window end as long as the current Mode stays active.

In a further aspect, Windows for the same Area cannot overlap. While a window is in effect, no other windows can take effect, consequently, ensuring that holds are always honored and that mode conflicts are not possible. Window overlap is prevented at the creation time of a window. For example, a Structure can have a recurring Sleep window. When creating a window for Extended Away at the Structure level, a prompt is displayed to the user indicating that “setting this extended away window will disable any existing sleep windows.”

In another aspect, Windows, at a higher level of the hierarchy 300, override windows in included entities. This occurs when the higher-level window takes effect, and it is a direct consequence of propagating attributes down the hierarchy. Hierarchical window overlap is prevented at creation time of a window. In an example, a Room is in an active “Winding Down” window. When the Sleep window of the Structure is activated, the Sleep window supersedes and overrides the Room's “Winding Down” state based on attributes overriding down the steps of the hierarchy.

In a further aspect, Transition modes are active at the beginning of the window. The Ingress Transition Mode is active when the window is active, but the Target Mode is not yet active. As illustrated in FIG. 5a, a Transition mode, such as the ingress mode 518 is active before the transition to the new mode 504.

In an additional aspect, estimated transition times are communicated to automations. The expected end of a window indicates the expected start time of the following Mode (e.g., announced arrival). This is communicated to partner services (e.g., via the partner service cloud 122) and an automation service when the window becomes active, every time that the end time of the window is updated while active, or in the case that the window is canceled. Partner services will be able to schedule when to start actions based on the expected end time (e.g., “Charge my EV fully by the time I wake up” or “Precondition my home by the time I return from vacation”). The automation service will be able to enable user automations based on static offsets from the expected end time (e.g., “Turn the lights on 1 hour before I come home”).

### Example Method

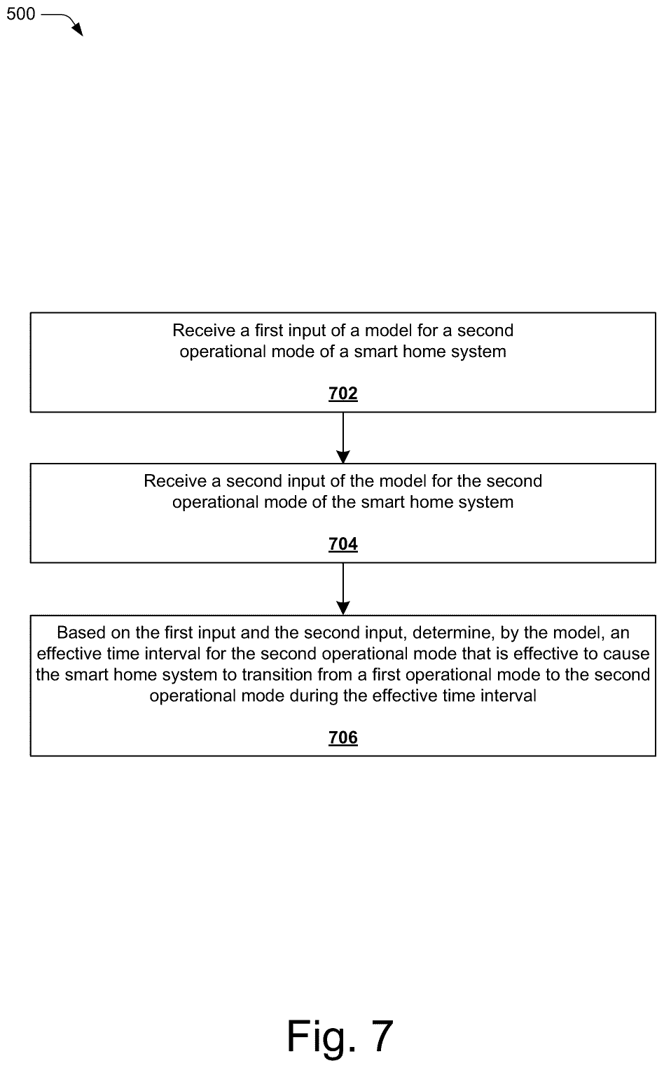

Example method 700 is described with reference to FIG. 7 in accordance with one or more aspects of hierarchical framework of contexts for the smart home. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the method blocks are described is not intended to be construed as a limitation, and any number of the described method blocks can be combined in any order or skipped to implement a method or an alternate method.

FIG. 7 illustrates example method(s) 700 of hierarchical framework of contexts for the smart home as generally related to determining an effective interval for a mode in a smart-home environment. At block 702, a model in an electronic device receives a first input of a model for a second operational mode of a smart home system. For example, the model (e.g., model 402) receives a learned window (e.g., learned window 404) or an explicit window (e.g., explicit window 406).

At block 704, the model receives a second input of the model for the second operational mode of the smart home system. For example, the model 402 receives a sensing input (e.g., sensing input 408) or a sensing input (e.g., sensing input 410).

At block 706, based on the first input and the second input, the model determines an effective time interval for the second operational mode that is effective to cause the smart home system to transition from a first operational mode to the second operational mode during the effective time interval. For example, the model 402 uses the first input and the second input to determine an effective time interval (e.g., effective interval 412) for the second operational mode (e.g., new mode 504) that is effective to cause the smart home system to transition from a first operational mode (e.g., current mode 502) to the second operational mode 504 during the effective time interval.

### Example Environments and Devices

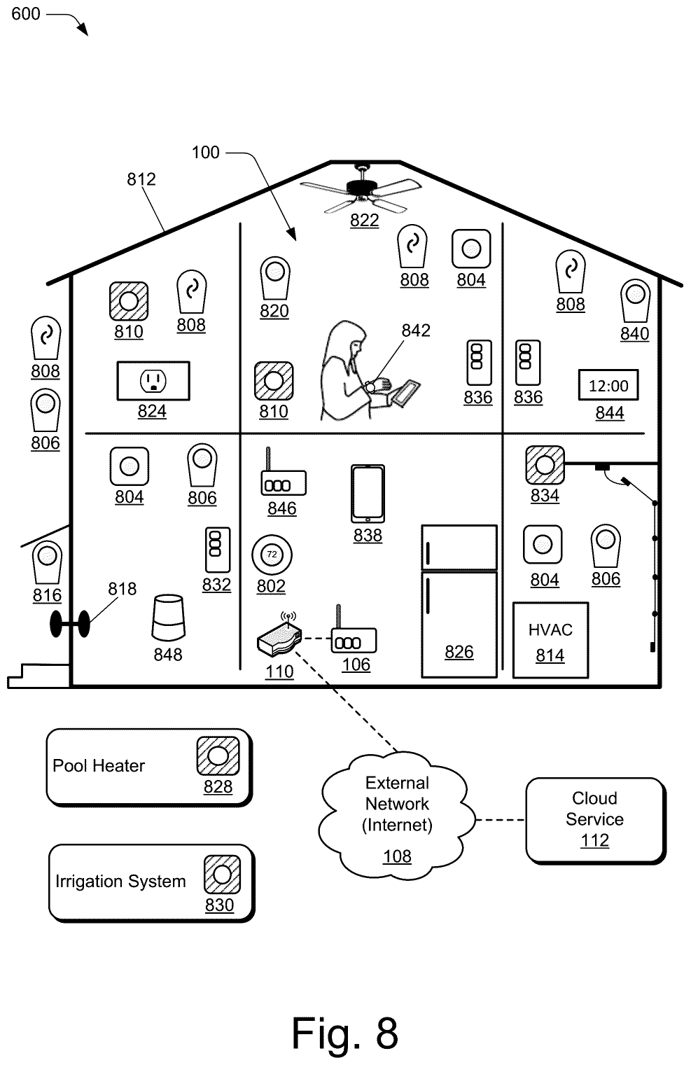

FIG. 8 illustrates an example environment 800 in which aspects of hierarchical framework of contexts for the smart home can be implemented. Generally, the environment 800 includes the home area network (HAN) 200 implemented as part of a home or other type of structure with any number of wireless network devices that are configured for communication in a wireless network. For example, the wireless network devices can include a thermostat 802, hazard detectors 804 (e.g., for smoke and/or carbon monoxide), cameras 806 (e.g., indoor and outdoor), lighting units 808 (e.g., indoor and outdoor), and any other types of wireless network devices 810 that are implemented inside and/or outside of a structure 812 (e.g., in a home environment), such as a smart or connected television. In this example, the wireless network devices can also include any of the previously described devices, such as a border router 106, as well as any of the devices implemented as a router device 206, and/or as an end device 208.

In the environment 800, any number of the wireless network devices can be implemented for wireless interconnection to wirelessly communicate and interact with each other. The wireless network devices are modular, intelligent, multi-sensing, network-connected devices that can integrate seamlessly with each other and/or with a central server or a cloud-computing system to provide any of a variety of useful automation objectives and implementations. An example of a wireless network device that can be implemented as any of the devices described herein is shown and described with reference to FIG. 7.

In implementations, the thermostat 802 may include a Nest® Learning Thermostat that detects ambient climate characteristics (e.g., temperature and/or humidity) and controls a HVAC system 814 in the home environment. The learning thermostat 802 and other network-connected devices “learn” by capturing occupant settings to the devices. For example, the thermostat learns preferred temperature set-points for mornings and evenings, and when the occupants of the structure are asleep or awake, as well as when the occupants are typically away or at home.

A hazard detector 804 can be implemented to detect the presence of a hazardous substance or a substance indicative of a hazardous substance (e.g., smoke, fire, or carbon monoxide). In examples of wireless interconnection, a hazard detector 804 may detect the presence of smoke, indicating a fire in the structure, in which case the hazard detector that first detects the smoke can broadcast a low-power wake-up signal to all of the connected wireless network devices. The other hazard detectors 804 can then receive the broadcast wake-up signal and initiate a high-power state for hazard detection and to receive wireless communications of alert messages. Further, the lighting units 808 can receive the broadcast wake-up signal and activate in the region of the detected hazard to illuminate and identify the problem area. In another example, the lighting units 808 may activate in one illumination color to indicate a problem area or region in the structure, such as for a detected fire or break-in, and activate in a different illumination color to indicate safe regions and/or escape routes out of the structure.

In various configurations, the wireless network devices 810 can include an entryway interface device 816 that functions in coordination with a network-connected door lock system 818, and that detects and responds to a person's approach to or departure from a location, such as an outer door of the structure 812. The entryway interface device 816 can interact with the other wireless network devices based on whether someone has approached or entered the smart-home environment. An entryway interface device 816 can control doorbell functionality, announce the approach or departure of a person via audio or visual means, and control settings on a security system, such as to activate or deactivate the security system when occupants come and go. The wireless network devices 810 can also include other sensors and detectors, such as to detect ambient lighting conditions, detect room-occupancy states (e.g., with an occupancy sensor 820), and control a power and/or dim state of one or more lights. In some instances, the sensors and/or detectors may also control a power state or speed of a fan, such as a ceiling fan 822. Further, the sensors and/or detectors may detect occupancy in a room or enclosure and control the supply of power to electrical outlets or devices 824, such as if a room or the structure is unoccupied.

The wireless network devices 810 may also include connected appliances and/or controlled systems 826, such as refrigerators, stoves and ovens, washers, dryers, air conditioners, pool heaters 828, irrigation systems 830, security systems 832, and so forth, as well as other electronic and computing devices, such as televisions, entertainment systems, computers, intercom systems, garage-door openers 834, ceiling fans 822, control panels 836, and the like. When plugged in, an appliance, device, or system can announce itself to the home area network as described above and can be automatically integrated with the controls and devices of the home area network, such as in the home. It should be noted that the wireless network devices 810 may include devices physically located outside of the structure, but within wireless communication range, such as a device controlling a swimming pool heater 828 or an irrigation system 830.

As described above, the HAN 200 includes a border router 106 that interfaces for communication with an external network, outside the HAN 200. The border router 106 connects to an access point 110, which connects to the access network 108, such as the Internet. A cloud service 112, which is connected via the access network 108, provides services related to and/or using the devices within the HAN 200. By way of example, the cloud service 112 can include applications for connecting end user devices 838, such as smartphones, tablets, and the like, to devices in the home area network, processing and presenting data acquired in the HAN 200 to end users, linking devices in one or more HANs 200 to user accounts of the cloud service 112, provisioning and updating devices in the HAN 200, implementing aspects of the model 402, and so forth. For example, a user can control the thermostat 802 and other wireless network devices in the home environment using a network-connected computer or portable device, such as a mobile phone or tablet device. Further, the wireless network devices can communicate information to any central server or cloud-computing system via the border router 106 and the access point 110. The data communications can be carried out using any of a variety of custom or standard wireless protocols (e.g., Wi-Fi, ZigBee for low power, 6LoWPAN, Thread, etc.) and/or by using any of a variety of custom or standard wired protocols (CAT6 Ethernet, HomePlug, etc.).

Any of the wireless network devices in the HAN 200 can serve as low-power and communication nodes to create the HAN 200 in the home environment. Individual low-power nodes of the network can regularly send out messages regarding what they are sensing, and the other low-powered nodes in the environment-in addition to sending out their own messages -can repeat the messages, thereby communicating the messages from node to node (i.e., from device to device) throughout the home area network. The wireless network devices can be implemented to conserve power, particularly when battery-powered, utilizing low-powered communication protocols to receive the messages, translate the messages to other communication protocols, and send the translated messages to other nodes and/or to a central server or cloud-computing system. For example, an occupancy and/or ambient light sensor can detect an occupant in a room as well as measure the ambient light, and activate the light source when the ambient light sensor 840 detects that the room is dark and when the occupancy sensor 820 detects that someone is in the room. Further, the sensor can include a low-power wireless communication chip (e.g., an IEEE 802.15.4 chip, a Thread chip, a ZigBee chip) that regularly sends out messages regarding the occupancy of the room and the amount of light in the room, including instantaneous messages coincident with the occupancy sensor detecting the presence of a person in the room. As mentioned above, these messages may be sent wirelessly, using the home area network, from node to node (e.g., network-connected device to network-connected device) within the home environment as well as over the Internet to a central server or cloud-computing system.

In other configurations, various ones of the wireless network devices can function as “tripwires” for an alarm system in the home environment. For example, in the event a perpetrator circumvents detection by alarm sensors located at windows, doors, and other entry points of the structure or environment, the alarm could still be triggered by receiving an occupancy, motion, heat, sound, etc. message from one or more of the low-powered mesh nodes in the home area network. In other implementations, the home area network can be used to automatically turn on and off the lighting units 808 as a person transitions from room to room in the structure. For example, the wireless network devices can detect the person's movement through the structure and communicate corresponding messages via the nodes of the home area network. Using the messages that indicate which rooms are occupied, other wireless network devices that receive the messages can activate and/or deactivate accordingly. As referred to above, the home area network can also be utilized to provide exit lighting in the event of an emergency, such as by turning on the appropriate lighting units 808 that lead to a safe exit. The light units 808 may also be turned-on to indicate the direction along an exit route that a person should travel to safely exit the structure.

The various wireless network devices may also be implemented to integrate and communicate with wearable computing devices 842, such as may be used to identify and locate an occupant of the structure, and adjust the temperature, lighting, sound system, and the like accordingly. In other implementations, RFID sensing (e.g., a person having an RFID bracelet, necklace, or key fob), synthetic vision techniques (e.g., video cameras and face recognition processors), audio techniques (e.g., voice, sound pattern, vibration pattern recognition), ultrasound sensing/imaging techniques, and infrared or near-field communication (NFC) techniques (e.g., a person wearing an infrared or NFC-capable smartphone), along with rules-based inference engines or artificial intelligence techniques that draw useful conclusions from the sensed information as to the location of an occupant in the structure or environment.

In other implementations, personal comfort-area networks, personal health-area networks, personal safety-area networks, and/or other such human-facing functionalities of service robots can be enhanced by logical integration with other wireless network devices and sensors in the environment according to rules-based inferencing techniques or artificial intelligence techniques for achieving better performance of these functionalities. In an example relating to a personal health-area, the system can detect whether a household pet is moving toward the current location of an occupant (e.g., using any of the wireless network devices and sensors), along with rules-based inferencing and artificial intelligence techniques. Similarly, a hazard detector service robot can be notified that the temperature and humidity levels are rising in a kitchen, and temporarily raise a hazard detection threshold, such as a smoke detection threshold, under an inference that any small increases in ambient smoke levels will most likely be due to cooking activity and not due to a genuinely hazardous condition. Any service robot that is configured for any type of monitoring, detecting, and/or servicing can be implemented as a mesh node device on the home area network, conforming to the wireless interconnection protocols for communicating on the home area network.

The wireless network devices 810 may also include a network-connected alarm clock 844 for each of the individual occupants of the structure in the home environment. For example, an occupant can customize and set an alarm device for a wake time, such as for the next day or week. Artificial intelligence can be used to consider occupant responses to the alarms when they go off and make inferences about preferred sleep patterns over time. An individual occupant can then be tracked in the home area network based on a unique signature of the person, which is determined based on data obtained from sensors located in the wireless network devices, such as sensors that include ultrasonic sensors, passive IR sensors, and the like. The unique signature of an occupant can be based on a combination of patterns of movement, voice, height, size, etc., as well as using facial recognition techniques.

In an example of wireless interconnection, the wake time for an individual can be associated with the thermostat 802 to control the HVAC system in an efficient manner so as to pre-heat or cool the structure to desired sleeping and awake temperature settings. The preferred settings can be learned over time, such as by capturing the temperatures set in the thermostat before the person goes to sleep and upon waking up. Collected data may also include biometric indications of a person, such as breathing patterns, heart rate, movement, etc., from which inferences are made based on this data in combination with data that indicates when the person actually wakes up. Other wireless network devices can use the data to provide other automation objectives, such as adjusting the thermostat 802 so as to pre-heat or cool the environment to a desired setting and turning-on or turning-off the lights 808.

In implementations, the wireless network devices can also be utilized for sound, vibration, and/or motion sensing such as to detect running water and determine inferences about water usage in a home environment based on algorithms and mapping of the water usage and consumption. This can be used to determine a signature or fingerprint of each water source in the home and is also referred to as “audio fingerprinting water usage.” Similarly, the wireless network devices can be utilized to detect the subtle sound, vibration, and/or motion of unwanted pests, such as mice and other rodents, as well as by termites, cockroaches, and other insects. The system can then notify an occupant of the suspected pests in the environment, such as with warning messages to help facilitate early detection and prevention.

The environment 800 may include one or more wireless network devices that function as a hub 846. The hub 846 may be a general-purpose home automation hub, or an application-specific hub, such as a security hub, an energy management hub, an HVAC hub, and so forth. The functionality of a hub 846 may also be integrated into any wireless network device, such as a network-connected thermostat device or the border router 106. Hosting functionality on the hub 846 in the structure 812 can improve reliability when the user's internet connection is unreliable, can reduce latency of operations that would normally have to connect to the cloud service 112, and can satisfy system and regulatory constraints around local access between wireless network devices.

Additionally, the example environment 800 includes a network-connected speaker (network-connected assistant device) 848. The network-connected speaker 848 provides voice assistant services that include providing voice control of network-connected devices. The functions of the hub 846 may be hosted in the network-connected speaker 848. The network-connected speaker 848 can be configured to communicate via the wireless mesh network 202, the Wi-Fi network 204, or both.

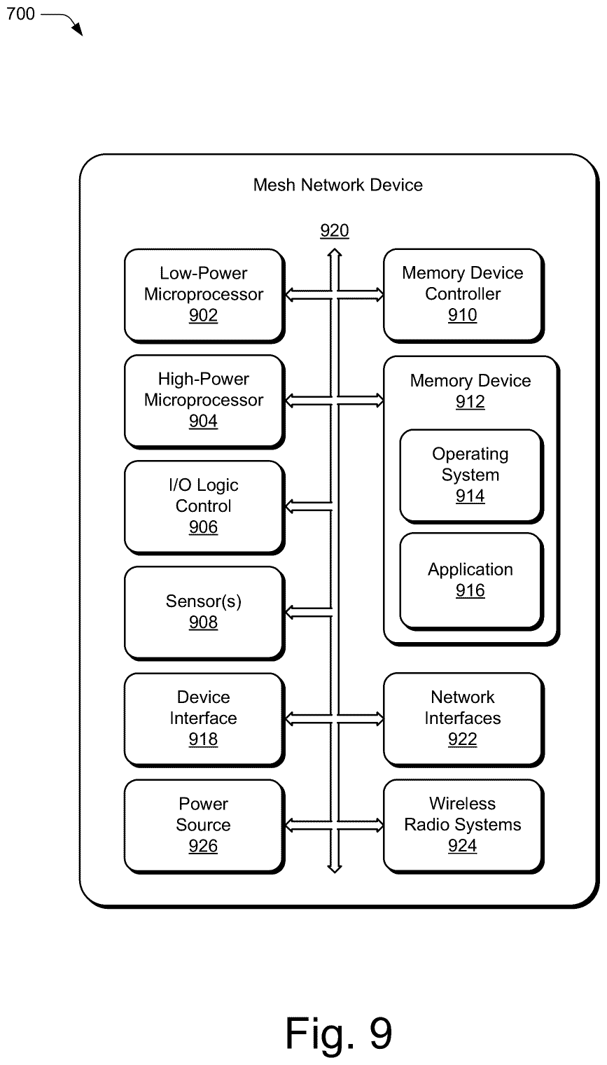

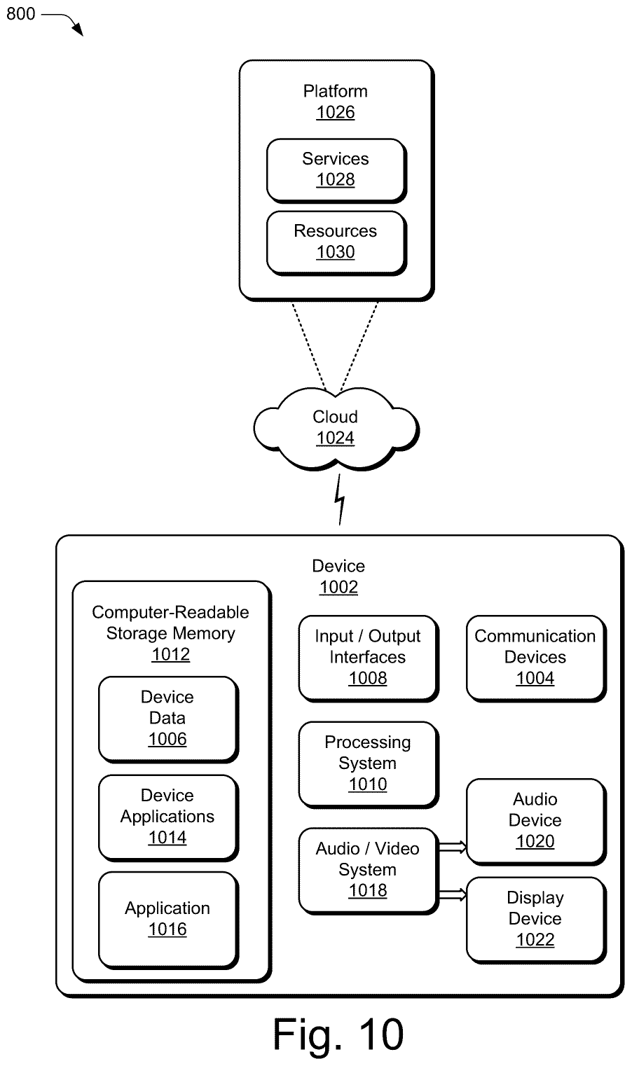

FIG. 9 illustrates an example wireless network device 900 that can be implemented as any of the wireless network devices (nodes) in a home area network (Thread network, fabric network, Weave network, Matter network) in accordance with one or more aspects of hierarchical framework of contexts for the smart home as described herein. The device 900 can be integrated with electronic circuitry, microprocessors, memory, input output (I/O) logic control, communication interfaces and components, as well as other hardware, firmware, and/or software to implement the device in a home area network. Further, the wireless network device 900 can be implemented with various components, such as with any number and combination of different components as further described with reference to the example device shown in FIG. 10.

In this example, the wireless network device 900 includes a low-power microprocessor 902 and a high-power microprocessor 904 (e.g., microcontrollers or digital signal processors) that process executable instructions. The device also includes an input-output (I/O) logic control 906 (e.g., to include electronic circuitry). The microprocessors can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The low-power microprocessor 902 and the high-power microprocessor 904 can also support one or more different device functionalities of the device. For example, the high-power microprocessor 904 may execute computationally intensive operations, whereas the low-power microprocessor 902 may manage less-complex processes such as detecting a hazard or temperature from one or more sensors 908. The low-power processor 902 may also wake or initialize the high-power processor 904 for computationally intensive processes.

The one or more sensors 908 can be implemented to detect various properties such as acceleration, temperature, humidity, water, supplied power, proximity, external motion, device motion, sound signals, ultrasound signals, light signals, fire, smoke, carbon monoxide, global-positioning-satellite (GPS) signals, radio frequency (RF), other electromagnetic signals or fields, or the like. As such, the sensors 908 may include any one or a combination of temperature sensors, humidity sensors, hazard-related sensors, other environmental sensors, accelerometers, microphones, optical sensors up to and including cameras (e.g., charged coupled-device or video cameras, active or passive radiation sensors, GPS receivers, and radio frequency identification detectors. In implementations, the wireless network device 900 may include one or more primary sensors, as well as one or more secondary sensors, such as primary sensors that sense data central to the core operation of the device (e.g., sensing a temperature in a thermostat or sensing smoke in a smoke detector), while the secondary sensors may sense other types of data (e.g., motion, light or sound), which can be used for energy-efficiency objectives or automation objectives.

The wireless network device 900 includes a memory device controller 910 and a memory device 912, such as any type of a nonvolatile memory and/or other suitable electronic data storage device. The wireless network device 900 can also include various firmware and/or software, such as an operating system 914 that is maintained as computer executable instructions by the memory and executed by a microprocessor. The device software may also include an application 916 that implements aspects of hierarchical framework of contexts for the smart home. The wireless network device 900 also includes a device interface 918 to interface with another device or peripheral component and includes an integrated data bus 920 that couples the various components of the wireless network device for data communication between the components. The data bus in the wireless network device may also be implemented as any one or a combination of different bus structures and/or bus architectures.

The device interface 918 may receive input from a user and/or provide information to the user (e.g., as a user interface), and a received input can be used to determine a setting. The device interface 918 may also include mechanical or virtual components that respond to a user input. For example, the user can mechanically move a sliding or rotatable component, or the motion along a touchpad may be detected, and such motions may correspond to a setting adjustment of the device. Physical and virtual movable user-interface components can allow the user to set a setting along a portion of an apparent continuum. The device interface 918 may also receive inputs from any number of peripherals, such as buttons, a keypad, a switch, a microphone, and an imager (e.g., a camera device).

The wireless network device 900 can include network interfaces 922, such as a home area network interface for communication with other wireless network devices in a home area network, wired network devices (e.g., Ethernet-connected devices), and an external network interface for network communication, such as via the Internet. The wireless network device 900 also includes wireless radio systems 924 for wireless communication with other wireless network devices via the home area network interface and for multiple, different wireless communications systems. The wireless radio systems 924 may include Wi-Fi, Bluetooth, Mobile Broadband, BLE, and/or point-to-point IEEE 802.15.4. Each of the different radio systems can include a radio device, antenna, and chipset that is implemented for a particular wireless communications technology. The wireless network device 900 also includes a power source 926, such as a battery and/or to connect the device to line voltage. An AC power source may also be used to charge the battery of the device.

FIG. 10 illustrates an example system 1000 that includes an example device 1002, which can be implemented as any of the wireless network devices that implement aspects of hierarchical framework of contexts for the smart home as described with reference to the previous FIGS. 1-9. The example device 1002 may be any type of computing device, client device, mobile phone, tablet, communication, entertainment, gaming, media playback, and/or other type of device. Further, the example device 1002 may be implemented as any other type of wireless network device that is configured for communication on a home area network, such as a thermostat, hazard detector, camera, light unit, commissioning device, router, border router, joiner router, joining device, end device, leader, access point, and/or other wireless network devices.

The device 1002 includes communication devices 1004 that enable wired and/or wireless communication of device data 1006, such as data that is communicated between the devices in a home area network, data that is being received, data scheduled for broadcast, data packets of the data, data that is synched between the devices, etc. The device data can include any type of communication data, as well as audio, video, and/or image data that is generated by applications executing on the device. The communication devices 1004 can also include transceivers for cellular phone communication and/or for network data communication.

The device 1002 also includes input/output (I/O) interfaces 1008, such as data network interfaces that provide connection and/or communication links between the device, data networks (e.g., a home area network, external network, etc.), and other devices. The I/O interfaces can be used to couple the device to any type of components, peripherals, and/or accessory devices. The I/O interfaces also include data input ports via which any type of data, media content, and/or inputs can be received, such as user inputs to the device, as well as any type of communication data, as well as audio, video, and/or image data received from any content and/or data source.

The device 1002 includes a processing system 1010 that may be implemented at least partially in hardware, such as with any type of microprocessors, controllers, and the like that process executable instructions. The processing system can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The device 1002 may further include any type of a system bus or other data and command transfer system that couples the various components within the device. A system bus can include any one or combination of different bus structures and architectures, as well as control and data lines.

The device 1002 also includes computer-readable storage memory 1012, such as data storage devices that can be accessed by a computing device, and that provide persistent storage of data and executable instructions (e.g., software applications, modules, programs, functions, and the like). The computer-readable storage memory described herein excludes propagating signals. Examples of computer-readable storage memory include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage memory in various memory device configurations.

The computer-readable storage memory 1012 provides storage of the device data 1006 and various device applications 1014, such as an operating system that is maintained as a software application with the computer-readable storage memory and executed by the processing system 1010. The device applications may also include a device manager, such as any form of a control application, software application, signal processing and control module, code that is native to a particular device, a hardware abstraction layer for a particular device, and so on. In this example, the device applications also include an application 1016 that implements aspects of hierarchical framework of contexts for the smart home, such as when the example device 1002 is implemented as any of the wireless network devices described herein.

The device 1002 also includes an audio and/or video system 1018 that generates audio data for an audio device 1020 and/or generates display data for a display device 1022. The audio device and/or the display device include any devices that process, display, and/or otherwise render audio, video, display, and/or image data, such as the image content of a digital photo. In implementations, the audio device and/or the display device are integrated components of the example device 1002. Alternatively, the audio device and/or the display device are external, peripheral components to the example device. In aspects, at least part of the techniques described for hierarchical framework of contexts for the smart home may be implemented in a distributed system, such as over a “cloud” 1024 in a platform 1026. The cloud 1024 includes and/or is representative of the platform 1026 for services 1028 and/or resources 1030.

The platform 1026 abstracts underlying functionality of hardware, such as server devices (e.g., included in the services 1028) and/or software resources (e.g., included as the resources 1030), and connects the example device 1002 with other devices, servers, etc. The resources 1030 may also include applications and/or data that can be utilized while computer processing is executed on servers that are remote from the example device 1002. Additionally, the services 1028 and/or the resources 1030 may facilitate subscriber network services, such as over the Internet, a cellular network, or Wi-Fi network. The platform 1026 may also serve to abstract and scale resources to service a demand for the resources 1030 that are implemented via the platform, such as in an interconnected device aspect with functionality distributed throughout the system 800. For example, the functionality may be implemented in part at the example device 1002 as well as via the platform 1026 that abstracts the functionality of the cloud 1024.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

Although aspects of hierarchical framework of contexts for the smart home have been described in language specific to features and/or methods, the subject of the appended claims is not necessarily limited to the specific features or methods described. Rather, the specific features and methods are disclosed as example implementations of hierarchical framework of contexts for the smart home, and other equivalent features and methods are intended to be within the scope of the appended claims. Further, various different aspects are described, and it is to be appreciated that each described aspect can be implemented independently or in connection with one or more other described aspects.

What is claimed is:

1. A method of managing modes in a smart home system by an electronic device, the method comprising:
receiving a first input of a model for a second operational mode of the smart home system;
receiving a second input of the model for the second operational mode of the smart home system; and
based on the first input and the second input, determining, by the model, an effective time interval for the second operational mode that is effective to cause the smart home system to transition from a first operational mode to the second operational mode during the effective time interval.

2. The method of claim 1, wherein the first input is a model learned by the electronic device, and wherein the learned model is based on historical data related to the operation of the smart home system.

3. The method of claim 1, wherein the first input is a time window input by a user.

4. The method of claim 1, wherein the second input comprises:
a sensing input;
a user input; or both.

5. The method of claim 4, wherein the sensing input comprises an input that provides sensing of a presence of occupants in a structure where the smart home system is deployed.

6. The method of claim 5, wherein the structure is at a root of a hierarchy of states related to the structure, wherein the structure includes states of one or more rooms, wherein the structure or rooms include states of zero or more occupants, wherein the presence of an occupant propagates up the hierarchy, the method comprising:
reconciling conflicts between the sensing input and the user input for an occupant to provide a consistent presence for the occupant in the hierarchy.

7. The method of claim 1, wherein the smart home system is deployed at a structure, wherein the structure is at a root of a hierarchy of states related to the structure, wherein the structure includes states of one or more rooms, wherein the structure or rooms include states of zero or more occupants, the method further comprising:
based on the determining the effective time interval, propagating a new state down the hierarchy of states related to the structure.

8. The method of claim 1, wherein the smart home system is deployed at a structure, wherein the structure is at a root of a hierarchy of states related to the structure, wherein the structure includes states of one or more rooms, wherein the structure or rooms include states of zero or more occupants, the method further comprising:
based on determining a change in a home or occupied presence in one of the one or more rooms, propagating a new presence state up the hierarchy of states related to the structure.

9. The method of claim 1, wherein the electronic device is one of:
a cloud server;
a hub; or
a border router.
